(19) United States
(12) Patent Application Publication
(10) Pub. No.: US 2011/0177199 A1
(43) Pub. Date: Jul. 21, 2011

(54) Method For Making A Sweet Potato Purée

(75) Inventors: Robert A. Harvey, St. Johnsville, NY (US); Shen-Youn Chang, Waterford, NY (US); Terry L. Rocklin, Fort Plain, NY (US); Gerald E. Shaul, Canajoharie, NY (US)

(73) Assignee: Beech-Nut Nutrition Corporation, Amsterdam, NY (US)

(21) Appl. No.: 12/689,764

(22) Filed: Jan. 19, 2010

(51) Int. Cl. A23L 1/216

(52) U.S. Cl. 426/64

(57) ABSTRACT

This invention provides a method for making a sweet potato purée comprising the steps of (a) admixing a coarse sweet potato purée with a suitable amount of glucoamylase, wherein (i) the coarse sweet potato purée is made using frozen sweet potatoes that have been puréed at a suitable temperature, and (ii) the admixing is performed at a temperature and for a duration sufficient to permit the glucoamylase to catalyze the breakdown of starch present in the coarse purée to maltose and glucose; and (b) heating the resulting purée at a temperature and for a duration sufficient to inactivate the glucoamylase present therein. The color, taste and texture of the resulting sweet potato purée are comparable to those of a sweet potato purée made from fresh sweet potatoes and containing only native glucoamylase.

Throughout this application, various publications are cited. The disclosure of these publications is hereby incorporated by reference into this application to describe more fully the state of the art to which this invention pertains.

### BACKGROUND OF THE INVENTION

Sweet potatoes are a very good source of vitamin A as well as potassium. As such, they are one of the staple vegetables for infants. Producing a sweet potato baby food has always been done using fresh sweet potatoes to get the best possible flavor and color.

The processing of sweet potatoes into a baby food purée requires that the fresh sweet potatoes be peeled to remove the skin and any surface blemishes. This is usually accomplished by a steam peeler but can also be accomplished using an abrasive peeler or a lye peeler. A secondary function of the steam peeler is to inactivate an enzyme (polyphenoloxidase) that darkens the potatoes once peeled and puréed. Once peeled, the potatoes are put through a device to produce a purée. This device, a therminutor, chops up the potatoes and adds steam to soften them. The purée is then heat-treated such that it is held at a constant temperature of about 160° F. for about 10 minutes. This step allows the natural amylase enzymes in the fresh sweet potatoes to break down some of the starch sugars, giving the resulting purée its characteristic sweet potato “flavor”, that is, a malty flavor. This in turn results from the enzymes' conversion of starch mainly to maltose and lesser amounts of sucrose, glucose and fructose. After this time, the purée is heated to 205° F. and held for two minutes. This step inactivates the amylase enzymes, thus stopping the breakdown of remaining starch. The product is then strained and processed.

The process of freezing sweet potatoes, so that the processor can eliminate the step of handling fresh sweet potatoes, inactivates the potatoes' natural amylase enzymes. A purée made from frozen sweet potatoes is very starchy with very little of the characteristic flavor and aroma associated with the typical cooked sweet potato.

The use of an aseptic purée as the raw ingredient for baby food purée has problems. The aseptic product must be produced at a qualified processor having FDA approval for the thermal process used. The use of an aseptic purée as starting material for a baby food purée yields a product that has a darker than normal color, and an overcooked flavor. This is due to the fact that the final purée has been thermally processed twice—once by the aseptic supplier and again by the baby food producer.

### SUMMARY OF THE INVENTION

This invention provides a method for making a sweet potato purée comprising the steps of
(a) admixing a coarse sweet potato purée with a suitable amount of glucoamylase, wherein (i) the coarse sweet potato purée is made using frozen sweet potatoes that have been puréed at a suitable temperature, and (ii) the admixing is performed at a temperature and for a duration sufficient to permit the glucoamylase to catalyze the breakdown of starch present in the coarse purée to maltose and glucose; and
(b) heating the resulting purée at a temperature and for a duration sufficient to inactivate the glucoamylase present therein;
wherein the color, taste and texture of the resulting sweet potato purée are comparable to those of a sweet potato purée made from fresh sweet potatoes and containing only native glucoamylase.

This invention also provides a sweet potato purée comprising an admixture of a pre-frozen sweet potato-derived purée and a suitable amount of exogenous glucoamylase, wherein the color, taste and texture of the sweet potato purée are comparable to those of a sweet potato purée made from fresh sweet potatoes and containing only native glucoamylase.

### DETAILED DESCRIPTION OF THE INVENTION

Terms

In this application, certain terms are used which shall have the meanings set forth as follows.

As used herein, “purée”, when used as a verb, shall include, without limitation, to rub through a strainer or process in a blender. When used as a noun, “purée” shall include, without limitation, food prepared by straining, stirring or blending.

As used herein, a “coarse purée” shall mean a purée to which no glucoamylase has been added.

As used herein, “glucoamylase” shall mean an amylase that cleaves the last alpha-1,4-glycosidic linkages at the non-reducing ends of starch, glycogen and other selected polysaccharide chains to yield glucose. Glucoamylase includes, without limitation, the enzyme produced by fungi such as those of the genus Aspergillus (e.g., Aspergillus niger). “Glucoamylase” is synonymous with glucan 1,4-α-glucosidase, γ-amylase, exo-1,4-α-glucosidase, amyloglucosidase, lysosomal α-glucosidase, and 1,4-α-D-glucan glucohydrolase. Glucoamylase is commercially available, and can be obtained, for example, in powder form (Valley Research, Ind.).

As used herein, a “suitable amount of glucoamylase”, with respect to the amount of glucoamylase to be added to coarse sweet potato purée, includes, without limitation, an amount of from (i) 0.08% to 0.16%, (ii) 0.10% to 0.14%, (iii) 0.11% to 0.13%, (iv) 0.10% to 0.13%, or (v) 0.11% to 0.14%. Preferably, a “suitable amount of glucoamylase”, with respect to the amount of glucoamylase to be added to coarse sweet potato purée, includes, without limitation, 0.115%, 0.116%, 0.117%, 0.118%, 0.119%, 0.12%, 0.121%, 0.122%, 0.123%, 0.124%, 0.125% and, most preferably, 0.12%. Here, “%” value means percent of the purée's weight. For example, one kilogram of a purée having “0.12%” glucoamylase contains 1.2 grams of glucoamylase.

As used herein, “frozen sweet potatoes” shall mean sweet potatoes frozen for any amount of time at any temperature. Frozen sweet potatoes include, without limitation, sweet potatoes frozen at a temperature of −90° F. or below, and/or frozen for at least five minutes. Preferably, frozen sweet potatoes are prepared according to IQF procedures well known in the art. (See, e.g., “Storage, Processing and Nutritional Quality of Fruits and Vegetables”, 2nd Edition, Volume II Processed Fruits and Vegetables, D. K. Salunkhe, H. R. Bolin, and N. R. Reddy, CRC Press, 1991, Chapter 4; and “Commercial Processing of Foods”, L. P. Hanson, Food Technology Review No. 27, NDC, 1975, pages 55 and 56.)

As used herein, a “suitable temperature” for puréeing a sweet potato includes, without limitation, 150° F.±10° F. (e.g., 140° F., 141° F., 142° F., 143° F., 144° F., 145° F., 146° F., 147° F., 148° F., 149° F., 150° F., 151° F., 152° F., 153° F., 154° F., 155° F., 156° F., 157° F., 158° F., 159° F. or 160° F.). Preferably, the suitable temperature for puréeing a sweet potato is 150° F.

As used herein, a duration “sufficient” to permit the glucoamylase to catalyze the breakdown of starch present in the coarse purée to maltose and glucose depends on the specific conditions employed. Suitable durations include, without limitation, 30±5 minutes (e.g., 25, 26, 27, 28, 29, 30, 31, 32, 33, 34 or 35 minutes). Preferably, the duration sufficient to permit the glucoamylase to catalyze the breakdown of starch present in the coarse purée to maltose and glucose is 30 minutes. “Inactivate”, when used with respect to glucoamylase, shall mean to reduce the activity of the glucoamylase by at least 90%. Preferably, inactivating the glucoamylase eliminates its activity entirely.

As used herein, a “temperature” and “duration” sufficient to inactivate the glucoamylase include, for example, at least 200° F. (e.g., 200° F., 201° F., 202° F., 203° F., 204° F., 205° F., 206° F., 207° F., 208° F., 209° F. or 210° F.) for between one and three minutes (e.g., two minutes).

### Embodiments of the Invention

This invention provides a method for making a sweet potato purée comprising the steps of
(a) admixing a coarse sweet potato purée with a suitable amount of glucoamylase, wherein (i) the coarse sweet potato purée is made using frozen sweet potatoes that have been puréed at a suitable temperature, and (ii) the admixing is performed at a temperature and for a duration sufficient to permit the glucoamylase to catalyze the breakdown of starch present in the coarse purée to maltose and glucose; and
(b) heating the resulting purée at a temperature and for a duration sufficient to inactivate the glucoamylase present therein;
wherein the color, taste and texture of the resulting sweet potato purée are comparable to those of a sweet potato purée made from fresh sweet potatoes and containing only native glucoamylase.

In the preferred embodiment of this method, in step (a), the coarse sweet potato purée is made from frozen sweet potatoes that have been processed using a therminutor. Preferably, in step (a), the frozen sweet potatoes have been processed using a therminutor at 150° F.±10° F. In one embodiment of this method, the glucoamylase catalyzes the breakdown of greater than 50% of the starch present in the coarse purée. In another embodiment, the glucoamylase catalyzes the breakdown of greater than 90% of the starch present in the coarse purée. Preferably, the resulting purée has one or more, and preferably all, of the following characteristics: (i) a dextrose equivalent of 40 or greater; (ii) glucose in an amount of from 5% to 5.25%; (iii) maltose in an amount of from 0.45% to 0.55%; and (iv) a total sugar content of from 7% to 9%.

In another preferred embodiment of this method, in step (a), the glucoamylase and coarse sweet potato purée are admixed at 150° F.±10° F. Preferably, in step (a), the glucoamylase and coarse sweet potato purée are admixed for a period of 25±5 minutes. Also, in step (b), the resulting purée is preferably heated at a temperature of at least 200° F. for at least two minutes.

In a further embodiment of this invention, this method further comprises the step of straining the sweet potato purée resulting from step (b).

This invention also provides a sweet potato purée comprising an admixture of a pre-frozen sweet potato-derived coarse purée and a suitable amount of exogenous glucoamylase, wherein the color, taste and texture of the sweet potato purée are comparable to those of a sweet potato purée made from fresh sweet potatoes and containing only native glucoamylase.

Preferably, the sweet potato purée is made according to the instant method.

This invention will be better understood by reference to the Experimental Details which follow, but those skilled in the art will readily appreciate that the specific experiments detailed are only illustrative of the invention as described more fully in the claims which follow thereafter.

Experimental Details

### EXAMPLE 1

### Preparation Method for Sweet Potato Purée

IQF frozen sweet potatoes were used as a starting source. With the natural enzymes having been inactivated by the freezing process, they were replaced with commercially available enzyme. The natural enzymes are amylase-type enzymes, and testing was first done with alpha-amylase. This produced a purée that had the right colour but the flavour was not a good match with the fresh sweet potato product. A different enzyme was then tried, namely, a glucoamylase enzyme. This enzyme works differently than a simple amylase. It functions to break down starch into maltose and glucose, producing a sweeter product than does amylase. The purée made from this process is very close to the purée produced from fresh sweet potatoes. The colour is a very good match with the product made from fresh sweet potatoes, as the purée has only been cooked once. The sweetness and characteristic flavour are also comparable to purée made from fresh sweet potatoes, and are superior to purée made using amylase.

Many test kitchen runs were performed to develop the processing parameters and show that using glucoamylase is preferable to using amylase to produce the final purée product.

An example of this preparation process is as follows:
(i) Dump IQF (individually quick-frozen) sweet potatoes over an inspection table.
(ii) Flow through a thermonutor set at 150° F.
(iii) Coarse purée is pumped into a holding tank, and the temperature is set at 150° F.±5° F.
(iv) A set amount of enzyme is added based on weight of potatoes in the tank, and is allowed to mix/react with the purée for 30 minutes.
(v) Purée is then heated to 205° F. and held for two minutes.
(vi) Purée is pumped through a finished strainer to the filler, filled into glass jars, and processed to commercial sterility.

This process is new in that (i) it produces a sweet potato product from a frozen ingredient whereby the product is comparable to that made using fresh sweet potatoes; and (ii) it uses a glucoamylase enzyme instead of just amylase to make a final product that is comparable to a product made using fresh sweet potatoes.

### EXAMPLE 2

### Sweet Potato Purée Color Data

Table 1 below shows color data for various sweet potato purée preparations. The following abbreviations are used: (i) “BNNC” represents Beech-Nut Nutrition Corp.; (ii) “%” enzyme means percent weight relative to total purée weight; (iii) “amylase” represents α-amylase; (iv) “AMG” represents glucoamylase; and (v) “hold” represents heating time at a fixed temperature.

TABLE 1
Sweet Potato Color Data

| | | | | Hunter Color Values | | | |
|---|---|---|---|---|---|---|---|
| Sample Identification/PP or TK Run brix | | TS | L | a | b | Process | Comments |
| Fresh BNNC 589 | 14.83 | 15.69 | 45.05 | 20.85 | 27.95 | fresh sweet potato | Good production sample |
| | | | | | | production | |
| Fresh BNNC 9428 | 12.38 | 12.99 | 46.16 | 21.65 | 28.68 | fresh sweet potato | Good production sample |
| | | | | | | production | |
| Gerber 19Aug10 2nd | 15.72 | 16.61 | 40.77 | 16.66 | 24.45 | Not known | Dark, off flavor |
| Gerber 16SEP10 2nd | 16.42 | | 39.95 | 17.67 | 24.69 | Not known | Dark, off flavor |
| Aseptic BNC 2011JA21 | 13.4 | 14.4 | 37.64 | 14.98 | 23.36 | aseptic sweet potato | Dark, off flavor |
| | | | | | | puree production | |
| Frozen production trial 9810 | 13.36 | 14.85 | 43.47 | 20.43 | 25.21 | frozen sweet potato and | Very comparable to |
| | | | | | | AMG production trial | production sample |
| Frozen Pilot plant trials | | | | | | | |
| 7095A | 10.47 | | 46.22 | 15.86 | 24.63 | | |
| 7095B | 10.59 | | 46.26 | 15.32 | 24.07 | | |
| 7102A | 10.81 | 13.56 | 46.76 | 17.29 | 24.4 | 0.12% amylase, 150° F., | Thick, good color, not |
| | | | | | | 20 minutes hold | sweet, bland flavor |
| 7102B | 11.21 | 12.66 | 43.84 | 17.2 | 24.12 | 0.12% amylase, 150° F., | Good consistency, color, |
| | | | | | | 30 minutes hold | sweetness, flavor not quite |
| | | | | | | | right |
| 7102C | 12.04 | 12.59 | 42.4 | 17.79 | 24.05 | 0.12% amylase, 150° F., | Good consistency, color, |
| | | | | | | 40 minutes hold | sweeter, flavor not quite |
| | | | | | | | right |
| 7103A | 10.93 | | 46.68 | 16.64 | 24.14 | 0.06 AMG/0.06% amylase, | Thick, good color, not |
| | | | | | | 150° F., 20 minutes hold | sweet, bland flavor |
| 71038 | 11.19 | | 46.51 | 17.18 | 24.12 | 0.06 AMG/0.06% amylase, | Thick, good color, sweeter |
| | | | | | | 150° F., 30 minutes hold | than “A”, bland flavor |
| 7103C | 11.77 | 12.87 | 42.75 | 16.44 | 24.14 | 0.06 AMG/0.06% amylase, | Good consistency, color, |
| | | | | | | 150° F., 40 minutes hold | sweetness, flavor not quite |
| | | | | | | | right |
| 7104A | 11.27 | | 48 | 17.88 | 25.36 | 0.24% amylase, 150° F., | Thick, good color, not |
| | | | | | | 10 minutes hold | sweet, bland flavor |
| 7104B | 12.37 | | 43.76 | 17.5 | 24.5 | 0.24% amylase, 150° F., | Thin, good color, sweeter |
| | | | | | | 20 minutes hold | than “A”, not quite right |
| | | | | | | | flavor |
| 7104C | 12.06 | | 42.52 | 18.75 | 24.21 | 0.24% amylase, 150° F., | Thin, good color, sweet, |
| | | | | | | 30 minutes hold | flavor not quite right |
| 7104D | 11.67 | | 45.03 | 18.22 | 25.11 | 0.24% amylase, 150° F., | Too thin, good color, sweet, |
| | | | | | | 40 minutes hold | flavor not quite right |
| 7105A | 11.11 | | 46.13 | 16.58 | 24.16 | 0.12% AMG, 150° F., | Thick, good color, not |
| | | | | | | 10 minutes hold | sweet, bland flavor |
| 7105B | 12.07 | | 42.42 | 17.14 | 24.14 | 0.12% AMG, 150° F., | Good consistency, good |
| | | | | | | 20 minutes hold | color, sweeter than “A”, |
| | | | | | | | flavor more like fresh |
| 7105C | 12.32 | | 41.79 | 16.88 | 23.74 | 0.12% AMG, 150° F., | Consistency, color, |
| | | | | | | 30 minutes hold | sweetness, and flavor |
| | | | | | | | match the fresh control |
| 7105D | 12.01 | | 42.12 | 16.7 | 24 | 0.12% AMG, 150° F., | Consistency getting to thin, |
| | | | | | | 40 minutes hold | color, sweetness, and flavor |
| | | | | | | | match the fresh control |
| 7106A | 11.09 | | 46.45 | 16.84 | 24.34 | 0.12% amylase, 170° F., | Thick, good color, not |
| | | | | | | 10 minutes hold | sweet, bland flavor |
| 7106B | 11.98 | | 45.96 | 17.92 | 24.49 | 0.12% amylase, 170° F., | Thin, good color, sweet, |
| | | | | | | 20 minutes hold | flavor not quite right |
| 7106C | 11.72 | | 42.2 | 17.78 | 23.66 | 0.12% amylase, 170° F., | Too thin, good color, sweet, |
| | | | | | | 30 minutes hold | flavor not quite right |
| 7106D | 11.72 | | 43.57 | 18.03 | 24.02 | 0.12% amylase, 170° F., | Too watery, good color, |
| | | | | | | 40 minutes hold | sweet, flavor not quite right |
| 7110 | 11.65 | | 46.49 | 18.57 | 24.54 | 0.03% AMG, 150° F., | Thick, color good,slight |
| | | | | | | 20 minutes hold | sweet, acid flavor |
| 7111 | 12.26 | | 42.15 | 17.18 | 23.67 | 0.03% AMG, 150° F., | Good consistency, color |
| | | | | | | 30 minutes hold | and sweetness, flavor okay |
| 7112 | 12.25 | | 42.15 | 17.6 | 23.74 | 0.03% AMG, 150° F., | A bit thin, good color, very |
| | | | | | | 40 minutes hold | sweet, acid flavor |
| 7113 | 11.07 | | 47.47 | 17.23 | 24.42 | 0.06% AMG, 150° F., | Thick, color good,slight |
| | | | | | | 20 minutes hold | sweet, acid flavor |
| 7114 | | | 42.14 | 18.07 | 23.41 | 0.06% AMG, 150° F., | Good consistency, color, |
| | | | | | | 30 minutes hold | flavor and sweetness |
| 7115 | | | 42.41 | 17.95 | 23.87 | 0.06% AMG, 150° F., | A bit thin, good color, very |
| | | | | | | 40 minutes hold | sweet, acid flavor |
| 7116 | 11.68 | 13.96 | 46.66 | 16.22 | 24.18 | 0.12% AMG, 150° F., | Thick, color good,slight |
| | | | | | | 20 minutes hold | sweet, acid flavor |
| 7117 | | | 41.85 | 17.1 | 23.6 | 0.12% AMG, 150° F., | Good consistency, very |
| | | | | | | 30 minutes hold | sweet, good color, acid |
| | | | | | | | flavor |
| 7118 | | | 41.67 | 17 | 23.25 | 0.12% AMG, 150° F., | A bit thin, good color, very |
| | | | | | | 40 minutes hold | sweet, acid flavor |
| 7119 | | | 43.21 | 19.67 | 23.56 | 0.12% AMG, 160° F., | Thick, good color, flavor |
| | | | | | | 20 minutes hold | okay slightly sweet |
| 7120 | 12.25 | | 43.24 | 17.3 | 24.46 | 0.12% AMG, 160° F., | Sweet, good consistency, |
| | | | | | | 30 minutes hold | flavor and color |
| 7121 | 11.47 | | 47.2 | 17.17 | 24.98 | 0.06% AMG, 160° F., | Thick, good color, flavor |
| | | | | | | 20 minutes hold | okay slightly sweet |
| 7122 | 12.32 | | 41.94 | 16.98 | 23.57 | 0.06% AMG, 160° F., | Thick, good color, flavor |
| | | | | | | 30 minutes hold | okay slightly sweeter |
| 7123 | 11.69 | | 44.52 | 18.98 | 24.3 | 0.03% AMG, 160° F., | Thick, good color, flavor |
| | | | | | | 20 minutes hold | okay slightly sweet |
| 7124 | 12.25 | | 42.7 | 18.41 | 24.02 | 0.03% AMG, 160° F., | Thick, good color, flavor |
| | | | | | | 30 minutes hold | okay slightly sweeter |

Notes-
Hunter color readings are as follows:
L white to gray scale-higher the number the lighter the color is
a green to red-higher negative numbers more green, higher positive numbers more red
b blue to yellow - higher negative numbers more blue, higher positive numbers more yellow
orange color is a mix of red and yellow

### EXAMPLE 3

### Sweet Potato Purée Sugars and Dextrose Equivalents

Table 2 below shows the sugar content and dextrose equivalents for various sweet potato purée preparations. The abbreviations used in Table 2 that also appear in Table 1 are already defined above. In addition, the term “dextrose equivalent” is used according to its industry-recognized meaning.

TABLE 2
Sugars and Dextrose Equivalent
Data forSelected Samples

| | | | Total | | | | | total | |
|---|---|---|---|---|---|---|---|---|---|
| | | Dextrose | Solids | fructose | glucose | sucrose | maltose | sugars | |
| Sample ID | Product Process Parameters | Equiv. | (%) | (%) | (%) | (%) | (%) | (%) | Comments |
| 7102B | 0.12% amylase, 150° F., | 24.31 | 12.69 | 0.54 | 0.74 | 1.15 | 1.78 | 4.21 | good consistency, color, |
| | 30 minutes hold | | | | | | | | sweetness, flavor not quite |
| | | | | | | | | | right |
| 7102C | 0.12% amylase, 150° F., | 29.72 | 12.78 | 0.55 | 0.65 | 1.09 | 2.6 | 4.89 | good consistency, color, |
| | 40 minutes hold | | | | | | | | sweeter, flavor not quite |
| | | | | | | | | | right |
| 7103B | 0.06 AMG/0.06% amylase, 150° F., | 20.83 | 13.45 | 0.52 | 0.73 | 1.49 | 1.55 | 4.29 | thick, good color, sweeter |
| | 30 minutes hold | | | | | | | | than “A”, bland flavor |
| 7103C | 0.06 AMG/0.06% amylase, 150° F., | 44.11 | 12.9 | 0.67 | 3.49 | 1.17 | 1.53 | 6.86 | good consistency, color, |
| | 40 minutes hold | | | | | | | | sweetness, flavor not quite |
| | | | | | | | | | right |
| 7105A | 0.12% AMG, 150° F., | 21.52 | 13.9 | 0.64 | 0.84 | 1.48 | 1.51 | 4.47 | thick, good color, not |
| | 10 minutes hold | | | | | | | | sweet, bland flavor |
| 7105B | 0.12% AMG, 150° F., | 34.91 | 13.2 | 0.58 | 2.27 | 1.49 | 1.76 | 6.1 | good consistency, good |
| | 20 minutes hold | | | | | | | | color, sweeter than “A”, |
| | | | | | | | | | flavor more like fresh |
| 7105C | 0.12% AMG, 150° F., | 49.84 | 13.42 | 0.97 | 5.23 | 1.2 | 0.49 | 7.89 | consistency, color, |
| | 30 minutes hold | | | | | | | | sweetness, and flavor |
| | | | | | | | | | match the fresh control |
| 7105D | 0.12% AMG, 150° F., | 48.31 | 13.06 | 0.84 | 5.47 | 0.98 | 0 | 7.29 | consistency too thin, color, |
| | 40 minutes hold | | | | | | | | sweetness, and flavor |
| | | | | | | | | | match the fresh control |
| 9810 | frozen sweet potato and AMG | 42.18 | 14.89 | 0.85 | 4.89 | 2.2 | 0.55 | 8.49 | very comparable to |
| | production trial | | | | | | | | production sample |
| Fresh | fresh sweet potato production | 31.61 | 16.1 | 0.69 | 0.91 | 3.38 | 3.49 | 8.47 | good production sample |
| BNNC 589 | | | | | | | | | |

What is claimed is:

1. A method for making a sweet potato purée comprising the steps of
(a) admixing a coarse sweet potato purée with a suitable amount of glucoamylase, wherein (i) the coarse sweet potato purée is made using frozen sweet potatoes that have been puréed at a suitable temperature, and (ii) the admixing is performed at a temperature and for a duration sufficient to permit the glucoamylase to catalyze the breakdown of starch present in the coarse purée to maltose and glucose; and
(b) heating the resulting purée at a temperature and for a duration sufficient to inactivate the glucoamylase present therein;
wherein the color, taste and texture of the resulting sweet potato purée are comparable to those of a sweet potato purée made from fresh sweet potatoes and containing only native glucoamylase.

2. The method of claim 1, wherein in step (a), the coarse sweet potato purée is made from frozen sweet potatoes that have been processed using a therminutor.

3. The method of claim 2, wherein in step (a), the frozen sweet potatoes have been processed using a therminutor at 150° F.±10° F.

4. The method of claim 1, wherein in step (a), the glucoamylase and coarse sweet potato purée are admixed at 150° F.±10° F.

5. The method of claim 4, wherein in step (a), the glucoamylase and coarse sweet potato purée are admixed for a period of 25±5 minutes.

6. The method of claim 1, wherein in step (b), the resulting purée is heated at a temperature of at least 200° F. for at least two minutes.

7. The method of claim 1, further comprising the step of straining the sweet potato purée resulting from step (b).

8. A sweet potato purée comprising an admixture of a pre-frozen sweet potato-derived purée and a suitable amount of exogenous glucoamylase, wherein the color, taste and texture of the sweet potato purée are comparable to those of a sweet potato purée made from fresh sweet potatoes and containing only native glucoamylase.

9. A sweet potato purée made according to the method of claim 1.
